(19) United States
(12) Patent Application Publication
(10) Pub. No.: US 2010/0169053 A1
(43) Pub. Date: Jul. 1, 2010

(54) Method for creating weldment inspection documents

(75) Inventors: Jeffrey A. Martis, Channahon, IL (US); Donald J. Hansen, Morris, IL (US); Anand Velankanni, Chennai (IN)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Chicago, IL (US)

(21) Appl. No.: 12/346,070

(22) Filed: Dec. 30, 2008

(51) Int. Cl. G06F 17/50

(52) U.S. Cl. 703/1

(57) ABSTRACT

A method for creating a weldment inspection document for identifying a plurality of weldment zones in a part accesses a representation of the part and selects weld zones in the representation of the part. The weld zones are marked with indicia concerning the location of and other information regarding weldments in the weld zone. A plurality of these representations are stored in a document depicting a weldment inspection sequence for the part.

### TECHNICAL FIELD

This patent disclosure relates generally to inspection methods and procedures and, more particularly, to a method for creating weldment inspection documents to be used in a manufacturing environment or the like.

### BACKGROUND

Entities that manufacture large industrial equipment, such as off-highway construction equipment and the like, often use multiple welding processes to join metal components together. Such entities often require welds of different types to form joints of different properties throughout the manufacturing process. These different weld types may be utilized with respect to the fabrication of individual parts, and several different weldments may appear on a single fabrication part and may be performed at the same or different stations in a manufacturing facility. Also, the manufacturing facility is often scaled so that different weld types are employed at stations over relatively large distances which may be spread over large manufacturing centers.

Due to the different weld types that may be employed in multiple areas of given fabrication parts, it is often difficult to adequately inspect the welds for quality assurance purposes, while at the same time, achieving efficient throughput on a given assembly line. That is, a weld inspector may have to regularly refer to a reference in order to verify that the particular weld or welds formed on a part under inspection meet specified requirements. The use of different personnel to inspect weldments at different stations may further cause a loss of efficiencies. For example, quality assurance personnel may be regularly transferred to different inspection locations within the plant.

To understand the nature and types of welds that are being inspected for a given part, such weld inspectors may be required to reference blueprint drawings of the part. In some cases, such drawings may not be organized in a logical fashion at the station of the weld inspector. Even if they can be located, the inspector may encounter hand-written notes or the like on the drawings which may be difficult to interpret and apply to the part being inspected. In these cases, the weld inspector may have to either stop or slow the assembly process in order to obtain an adequate understanding of the weldments that should be formed on the part.

Such increase in the overall inspection time reduces the efficiency of the manufacturing process. When such inspection processes are critical path elements in the manufacture or assembly of equipment, such increased inspection times may lead to increased manufacture or assembly time for such equipment.

### SUMMARY

The disclosure describes, in one aspect, a method for creating a grouping of weldment inspection pages into one or more inspection documents. The weldment inspection document provides an inspection sequence with respect to a part that is made in a manufacturing process. The method includes accessing an editable representation of the part. Next, the method selects a first weld zone from the editable representation of the part. Indicia concerning the location of and other information regarding at least one weldment are marked in the first weld zone. The method then stores the first weld zone with the indicia and other information as a first weldment inspection page. These selecting and repeating steps are repeated with respect to a second weld zone for the part. The second weld zone, with indicia and other information, is stored as a second weldment inspection page. The first weldment inspection page and the second weldment inspection page are sequenced or ordered as a weldment inspection document according to a weldment inspection sequence for the part.

In another aspect, the disclosure describes a method for making a part based on a standardized weldment inspection document. The standardized inspection document provides an inspection sequence with respect to the weldments located on a part that is made in a manufacturing process. In this case, the standardized weldment inspection document includes identifications of weldments and associated weld types that are arranged in a predetermined sequence. The method includes accessing the standardized weldment inspection document. Next, the method inspects a first weldment zone in the part and determines whether the first weldment zone meets a first criteria according to the first indentified weld zone provided in the document. Next, the method inspects the second weldment zone in the part and determines whether the second weldment zone meets a second criteria according the second indentified weld zone provided in the document. The process is repeated until the weldment zones of the part are inspected. The part is then transferred to another location if the first weld zone criteria and the second weld zone criteria are met.

In yet another aspect, the disclosure describes a physical computer readable medium containing computer executable instructions for creating a weldment inspection document from a grouping of weldment inspection pages provided in an inspection sequence. The weldment inspection document is provided with respect to a part that is made in a manufacturing process. The executable instructions operate according to a method that includes accessing a three-dimensional electronic representation of the part and converting the three-dimensional electronic representation to an editable representation of the part. The method then receives via a computer interface input from a user selecting a first weld zone in editable representation of the part. The method also receives from the user indicia concerning the location and other information regarding weldments in the selected first weld zone. These steps are repeated until indicia regarding weldments in remaining weld zones for the part are identified. The weld zones with the indicia concerning the location and other information for the weld zones in the part as a plurality of weldment inspection pages are stored. Next, the method receives via a computer interface input from a user commands for ordering the plurality of weldment inspection pages in a predefined weldment inspection sequence for the part.

### BRIEF DESCRIPTION OF THE DRAWINGS

FIG. 1 is a high-level block diagram representation of various interacting departments in an organization according to the disclosure.

FIG. 2 is a flow diagram illustrating a method for creating a document of weldment inspection documents according to the disclosure.

FIG. 3 is a flow diagram illustrating a method for inspecting a part according to a inspection sequence provided in a weldment inspection document.

FIG. 4 is an exemplary index page of a weldment inspection document or compilation in accordance with the disclosure.

FIG. 5 is an exemplary succeeding page of the weldment inspection document shown in FIG. 4.

FIG. 6 is another exemplary succeeding page of the weldment inspection document shown in FIG. 4.

### DETAILED DESCRIPTION

This disclosure relates to methods for creating weldment inspection documents for use in a production area of a manufacturing facility. A plurality of weld zones in a part are marked with indicia concerning the location of and other information regarding welds that are provided in the weld zones. The weld zones are aggregated in a weldment inspection document according to a defined inspection sequence. Inspection personnel may use such weldment inspection documents to quickly and efficiently discover relevant inspection zones on the part.

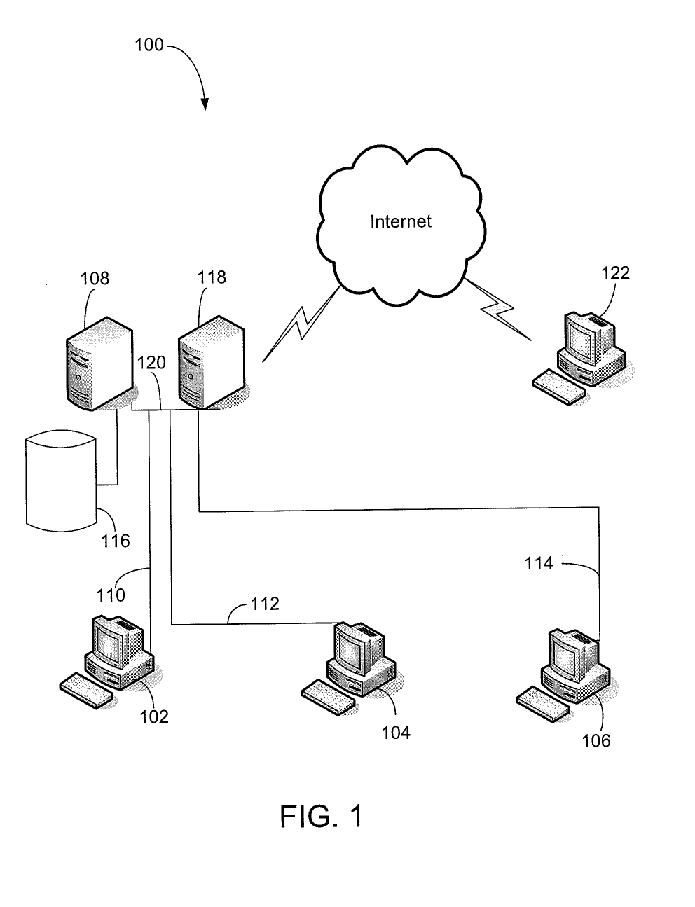

FIG. 1 is a block diagram representation of an interconnected computing environment 100 in which the disclosure may be deployed. In this case, various computing systems are located throughout a manufacturing entity or organization. As illustrated, the interconnected computing environment 100 may include one or more computing systems that are disposed in various departments of the organization, such as an engineering department computing system 102, a process inspection department computing system 104, and an assembly line computing system 106. While one system is shown for illustrative purposes, those skilled in the art will appreciate that multiple computing systems, including networked systems, may be located in these or in other departments in the organization.

Each of the engineering department computing system 102, the process inspection computing system 104 and the assembly line computing system 106 is connected to a back-end server 108 via respective communication links 110, 112 and 114, respectively. The back-end server 108, in turn, accesses a data store 116 for the organization. The back-end server 108, as well as the engineering department computing system 102, the process inspection computing system 104 and the assembly line computing system 106, are also connected to a web server 118 via a communication link 120. The web server 118 may communicate with one or more computing systems that are remotely located, such as an illustrated remote computing system 122. In the illustrated embodiment, the web server 118 communicates with the remote computing system 122 via the Internet in a known fashion. Those skilled in the art will appreciate that many different organization structures may be used in accordance with the disclosure.

In the illustrated interconnected computing environment 100, the engineering department computing system 102, the process inspection computing system 104 and the assembly line computing system 106 may access data maintained in the data store 116 by making appropriate requests to the back-end server 108. Among other things, the back-end server 108 may execute software that is disposed to manage products, systems and/or parts that are fabricated by the organization. One type of such software may include a product lifecycle management (PLM) software that is disposed to manage descriptions and properties of a product, including various subsystems and components of the product. The PLM software stores representations of the various parts, components, subsystems and the like in various forms. In an illustrated embodiment, the PLM software stores such parts, components and the like as three-dimensional graphical representations thereof.

Such graphical representations may be maintained in the data store 116 as separate objects or files of a known format, such as XML or the like. These files are associated with the appropriate part, component and/or subsystem, preferably through indexing or by assigning a suitable naming convention such that the files are stored in memory in a logical fashion. Because the PLM software is often required to integrate data and files from various other software applications across an organization, it is preferably configured to allow communication among other applications, in various operating environments. One suitable PLM software is Teamcenter 2007 (or similar version), a software package that is marketed by Siemens. In an embodiment, while the various departments may access read-only versions of the data corresponding to the various components and parts, only computing systems with certain credentials (such as the engineering department computing system 102) may alter the data.

As contemplated, the various computing systems, such as the engineering department computing system 102, the process inspection computing system 104 and the assembly line computing system 106, each preferably include a User Interface (UI). The UI is capable of receiving input from a user to enable the creation or manipulation of the files and objects concerning the components and/or subsystems according to the user's preferences. Preferably, the UI may be divided into sub-windows that permit various frequently used operations and tasks to be available through human-computer interaction.

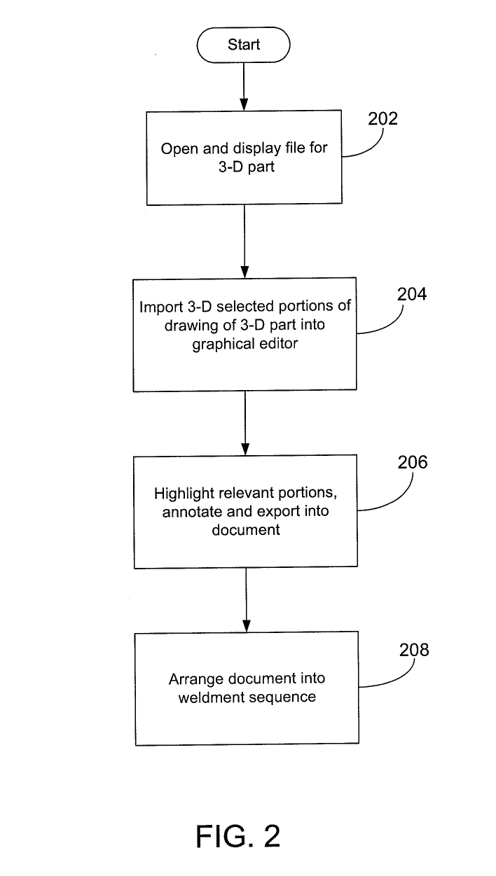

FIG. 2 is a process flow diagram illustrating a method for creating a page or individual file of a weldment inspection document according to the disclosure. The operations described below relative to the flow diagram presented are operations that may be performed by a computing system. By way of example, suitable computing systems include one or more of the computing systems shown in FIG. 1, in accordance with appropriate software being executed therein. That is, certain steps of the disclosed process may be executed by a computing system via the execution of computer-executable instructions, e.g., in machine language form or otherwise, read from a computer-readable medium, e.g., a magnetic or optical disc or other tangible medium. While the methodology is described with reference to the engineering department computing system 102, the process inspection computing system 104 or the assembly line computing system 106 shown in FIG. 1, the method is applicable to any computing system that is used in connection with manufacturing operations. Also, while a particular sequence is shown for convenience, the disclosure is applicable to creating inspection documents according to different steps as well.

The process shown in FIG. 2 proceeds as follows. First, a user, for example a user operating the process inspection computing system 104, opens a file containing a representation of a part at a first stage 202. In an embodiment, the representation is contained in a file that is accessed from the database disposed at the data store 116. The file containing the representation is opened through an appropriate application, such as a viewer application, that is executing on the process inspection computing system 104.

While not necessarily so, the representation may have been created by a user of the engineering department computing system 102, as part of the design of the particular part. The representation is preferably a three-dimensional rendering or model of the part that illustrates various weldment details concerning the part in an intuitive, user-friendly format. When displayed on the screen of the process inspection computing system 104 in a view mode, the representation is presented in a format that can be manipulated through conventional human-computer editing interactions. These may include mouse and/or keyboard selection, cutting and/or copying operations. In this way, the user may select, at the first stage 202, the appropriate portion or portions of the representation that illustrates weldment location and details on the part of interest.

At a second stage 204, the file containing the three-dimensional representation is imported into a graphical editor. In the illustrated embodiment, the user selects relevant weld zones and copies them as individual files into the graphical editor. That is, the user selects a portion of the three-dimensional representation that illustrates localized areas of a particular weldment or grouping of weldments in proximity to each other. Next, using the graphical editor, the user highlights the relevant weldment zones at a marking stage 206. At this stage, the user provides an easy to understand marking as to the location of the weldment depicted in the local portion for the part. In addition, the user may provide certain information as to the type of weldment under inspection at the marking stage 206.

At a compilation stage 208, the user exports the annotated portion of the part to a file of another application, such as a presentation application or other suitable application that may generate pages of text, graphics or other objects that may be readily arranged on the page. In this way, the user may arrange the highlighted and annotated weld zones according to a specified inspection sequence. As explained in greater detail below, the inspection sequence is preferably captured within a document, which includes an index listing of the inspection sequence followed by pages arranged according to the inspection sequence. Because the part under inspection in a described example is a large steel structure, such as an off-highway machine frame, many weldments of different types are included in the weldment pages according to the inspection sequence.

In an embodiment, various steps that are performed according to the sequence of FIG. 2 may be automated or at least partially automated. For example, the graphical editor may expose a palette, a drop down menu, a tool bar or the like of commonly used functions that are used to create the highlighted or annotated weld zones. Such functions may include markers for identifying certain weld locations, common weld type selection tools and the like to ease the identification of weld location and type on the weld zones that have been selected. This may improve uniformity and consistency in the building and presentation of the weldment inspection documents that are created according to the disclosure.

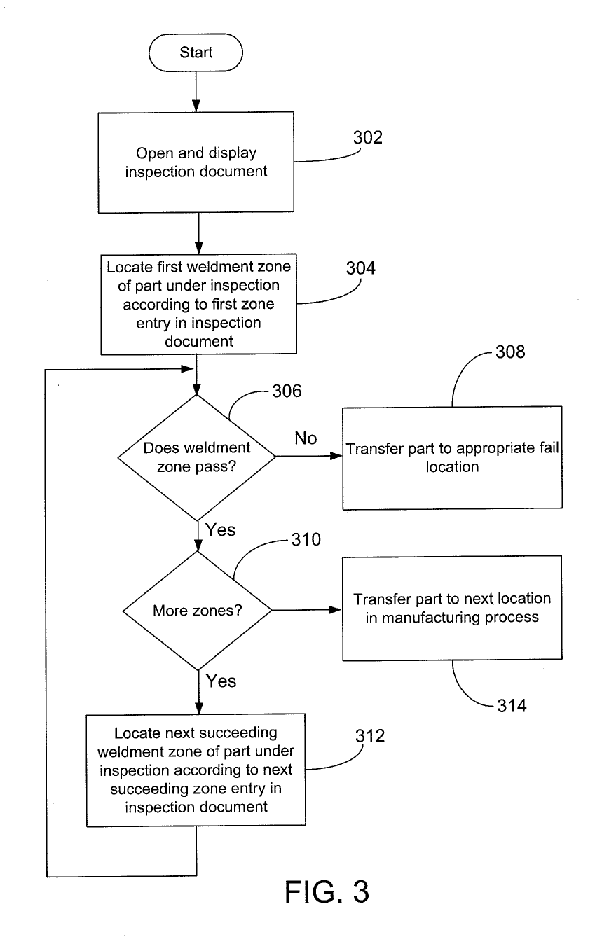

FIG. 3 is a flow diagram illustrating a method for inspecting a part according to an inspection sequence provided in a weldment inspection document. In this case, an individual stationed at the computing system 106 disposed at or near an assembly line is likely to perform the various steps described herein through interaction with the computing system 106. The method in this case begins at a first processing stage 302 in which an inspection document for a part, which was created according to the method of FIG. 2, is opened. Next, at a first locating stage 304, a first weldment zone of the part under inspection is located according the first weld zone entry contained in the weldment inspection document.

At a first decision stage 306, the method determines whether the discovered weldment zone passes inspection. That is, by reference to the location, and information concerning the type of weld present, the inspector determines whether the weldment zone on the part meets the location and type requirements provided in the inspection document, and specifically, with respect to the first zone entry in the inspection document. Because the inspection document according to a preferred embodiment depicts the first weld zone as a three-dimensional representation, the user may readily locate the corresponding weld on the part under inspection. If, at the first decision stage 306, the first weld on the part does not pass inspection, then the method proceeds to a first transfer stage 308 in which the part is transferred to a fail location. Thereafter, the part may be reworked or further analyzed to discover reasons for failure of the inspection.

On the other hand, if the weldment zone passes inspection at the first decision stage 306, the method proceeds to a second decision stage 310 to determine whether any additional weld zones are present on the part. This is accomplished though reference to the inspection document. If no additional weldment zones are to be inspected, the method proceeds to a second transfer stage 314 and the part is transferred to the next location in the manufacturing process.

However, if at the second decision stage 310, additional weldment zones are to be inspected, the method proceeds to a second locating stage 312. At the second locating stage, the next succeeding weldment zone for the part is located according to entries contained in the inspection document. The method then proceeds back to the first decision stage 306 and determines whether such succeeding weldment zone on the part passes inspection. The method then continues as described above.

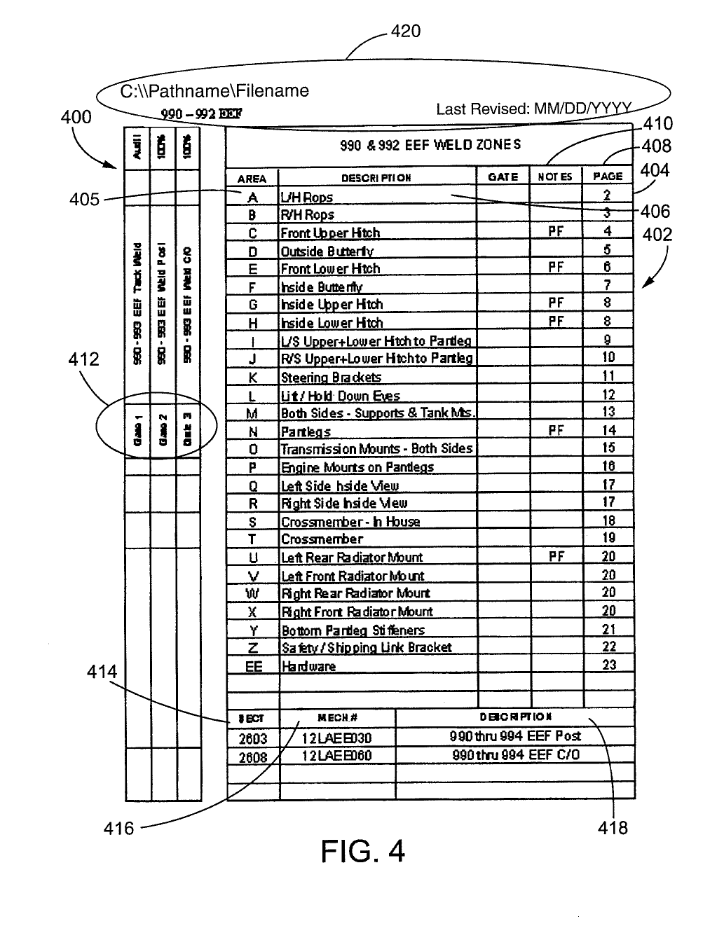

FIG. 4 is an exemplary cover sheet 400 or index page of a weldment inspection document in accordance with the disclosure. In this case, the cover sheet 400 contains an identification of the weldment zones contained within the document organized as a weld zone listing 402. The weld zone listing 402 includes a plurality of weld zone entries, such as a first weld zone entry 404. In the illustrated embodiment, each weld zone entry includes an Area field 405 that may designate an area on the part being inspected, a Description field 406 that may provide a description of an area of the part being inspected, a Page field 408 that identifies the page number of the document. The weld zone listing 402 optionally includes additional fields such as an Other Details field 410 that indicates whether one or more components welded to the part require inspection. The cover sheet 400 may refer to parts of a similar type such as different types of frames for off-highway machines that are being fabricated on the same assembly line of the factory.

In addition to the weld zone listing 402, the cover sheet 400 includes information concerning the location in which certain weldment operations are performed on the part being inspected. For example, the cover sheet 400 may include a Gate identifying portion 412 that identifies the staging location in which the part may be placed so that certain welding operations are performed. That is, the Gate identifying portion 412 may provide information to the weld inspector as to the location in which weldments of a first type, such as a tack weld as depicted in FIG. 4. The Gate identifying portion 412 may provide other type or position information concerning weldments with respect to the part or parts under inspection. Other information concerning the fabrication of the relevant part or parts within a factory, such as a section within the factory where the part or parts are fabricated, may be maintained in a Section field 414. The cover sheet 400 may also include Mechanism field 416 that identifies a sequence of steps that are performed, such as through a robotic system or the like, on the part or parts under inspection. Finally, the cover sheet 400 may include Part identifying fields 418 that identify the particular parts being inspected as well as a header 420 for the document.

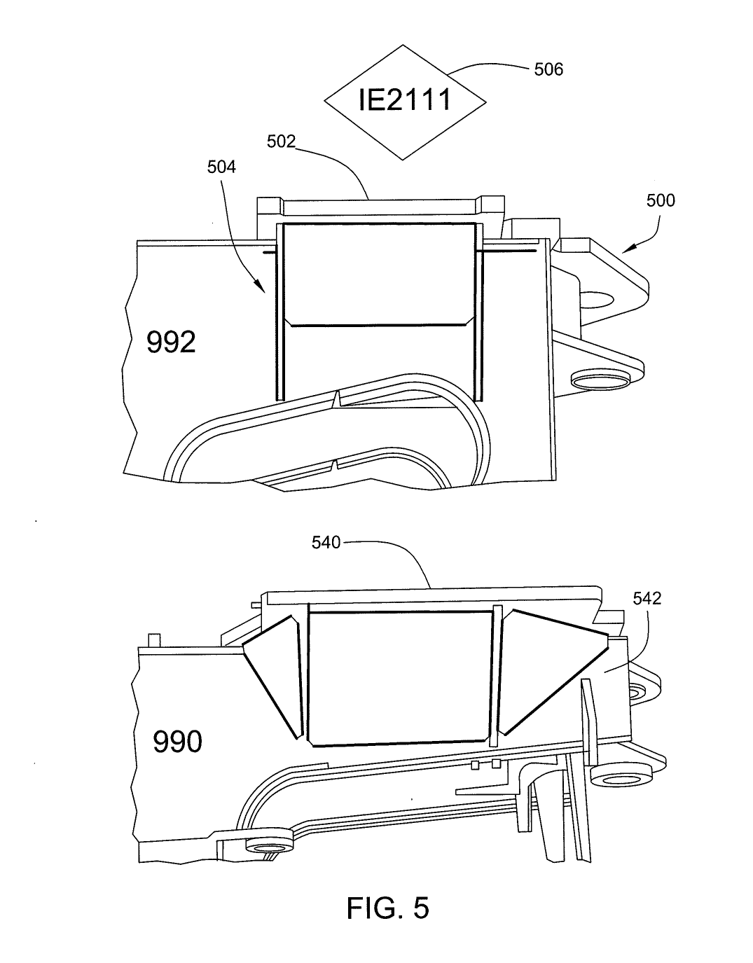

FIG. 5 is an exemplary second page or first succeeding page 500 of the weldment inspection document shown in FIG. 4. The first succeeding page 500 provides visual information and cues concerning weldments of interest on a part or parts. In FIG. 5, the first succeeding page 500 presents an image of an enlarged weld zone 502 that is to be located on a first part, enumerated as “992.” The illustrated weld zone 502 has a first location notation 504 that plainly designates the location of the weldment of interest within the three-dimensional depiction of the weld zone 502. The first location notation 504 may take the form of an outline with respect to the particular weldment in a contrasting coloration, such as a red outline coloration. In addition, the succeeding page 500 includes an indicator 506 that specifies a type of weldment identified within the first location notation 504. Among other things, the indicator 506 may identify the type of solder used to form the weldment.

The first succeeding page 500 may also include information concerning a weld zone 540, which is disposed in a similar area as the weld zone 502, albeit with respect to another part. In this case, the relevant part is enumerated as “990” in the first succeeding page 500. The weld zone 540 also includes a second location notation 542 that clearly identifies the location of a weldment disposed within the weld zone 540. Specifically, the second location notation 542 includes highlighting of the weldment on the three-dimensional depiction of the weld zone 540. Both the weld zone 502 and the weld zone 540 correspond to a particular location as to parts, in this case frames, of a similar type.

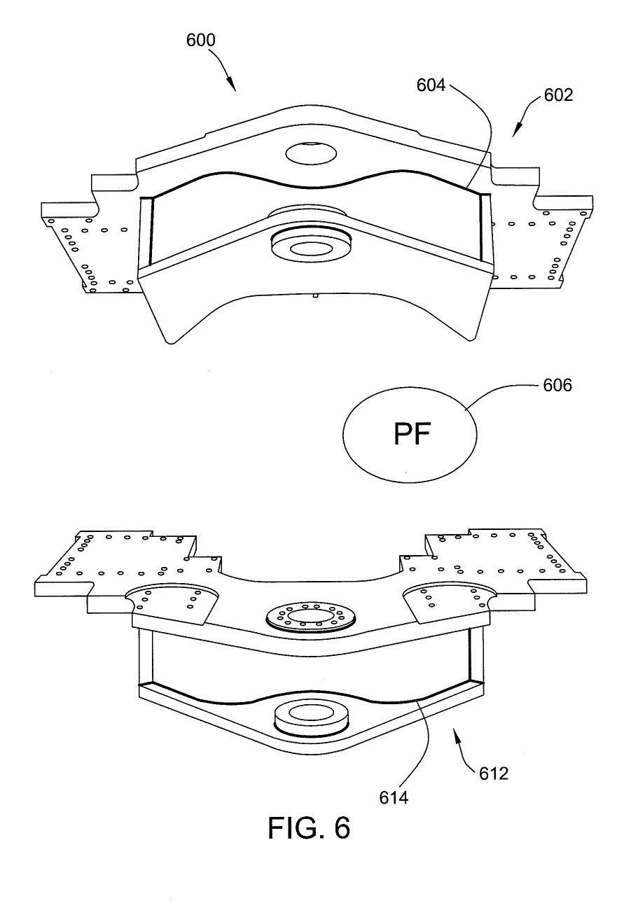

FIG. 6 illustrates an exemplary next succeeding page 600 of the weldment inspection document shown in FIG. 4. Specifically, FIG. 6 illustrates a second inspection zone 602 disposed on another depiction of a component of the part designated as “992” in FIG. 5. The inspection zone 602 includes a third location notation 604 that designates a different type of inspection. In this case, an indicator 606 provides information concerning the highlighted location (according to the third location notation 604) as a “purchase finished” component. Therefore, the inspector may perform a different inspection with respect to the location corresponding to the third location notation 604, such as a spot inspection or the like. Similarly, an inspection zone 612, corresponding to a component for a complementary part designated as “990” in FIG. 4, includes a fourth location notation 614. The fourth location notation 614 outlines a similar location in the part “990” as a “purchase finished” component. Therefore, the inspector may perform a similar inspection as the inspection performed with respect to the inspection zone 602. The annotation information may vary according to the particular implementation.

As explained above, the various pages, such the illustrated pages 400, 500 and 600, are arranged according to an inspection sequence. That is, to create inspection documents, the user arranges the document pages in an order that the corresponding weld zones are expected to be encountered during an inspection. In addition, a cover or index page, such as the cover sheet 400 illustrated in FIG. 4, provides a roadmap for the inspector to navigate in order to find a particular weld zone or zones of interest. In this way, the inspector is provided with a logical series of visual representations of particular portions of a part plainly illustrating weldments or other component or part features to be inspected. Accordingly, a plurality of related files containing such weld zones may be provided in a single document, such as by importing the files into a container. That is, the various edited files may be imported into a container file, such as in a presentation application file, in which they are aggregated and compiled according to the inspection sequence desired.

### INDUSTRIAL APPLICABILITY

Accordingly, a weldment inspection methodology that simplifies the inspection process has been described. The industrial applicability of the weldment inspection method as described herein should be readily appreciated from the foregoing discussion. The present disclosure may be included as part of an overall inspection process in which quality inspectors are required to quickly locate and inspect weldments as part of a manufacturing process.

Various advantages may be obtained from implementation of the disclosed methods. For example, the weldment documentation is easily understandable for qualified inspectors and new quality inspectors alike. Moreover, the inspection time is likely to be reduced, often by a factor of one-half. Also, the disclosure is likely to reduce clutter in the process inspection workspace as manually marked up blueprint drawings, loose papers and the like

The disclosure, therefore, is applicable to the inspection of various fabricated parts and components. Exemplary items that are suited for inspection according to the disclosure are large metal structures, such as off-highway machine frames. Such frames may be used to manufacture off-highway off-highway machines commonly used in mines, construction sites, and quarries. Such machines have significant load demands, and therefore, require multiple weldments of different types. Accordingly, organization of inspection sequence information and documentation of the inspection results are difficult given the large number of weldments and the different frame types that may be encountered.

It will be appreciated that the foregoing description provides examples of the disclosed methodology. It is contemplated that other implementations of the disclosure may differ in detail from the foregoing examples. All references to the disclosure or examples thereof are intended to reference the particular example being discussed at that point and are not intended to imply any limitation as to the scope of the disclosure more generally.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method for creating a grouping of weldment inspection pages as a document providing an inspection sequence with respect to a part that is made in a manufacturing process comprising:
accessing an editable representation of the part,
selecting a first weld zone from the editable representation of the part,
marking the first weld zone with indicia concerning the location of and other information regarding at least one weldment in the first weld zone,
storing the first weld zone with the indicia and other information as a first weldment inspection page,
repeating the selecting and marking steps with respect to a second weld zone for the part and storing the second weld zone with indicia and other information as a second weldment inspection page, and
ordering the first weldment inspection page and the second weldment inspection page as a weldment inspection document providing a weldment inspection sequence for the part.

2. The method of claim 1, further including the steps of
accessing a first representation of the part, and
converting the first representation into the editable representation of the part.

3. The method of claim 2, wherein the first representation of the part is a three-dimensional representation.

4. The method of claim 3, further including the steps of
selecting a third weld zone from the editable representation of the part,
marking the third weld zone with indicia concerning a location of a component finish type in the third weld zone, and
storing the third weld zone with the indicia and other information as a third weldment inspection page.

5. The method of claim 4, further including the step of providing an index for the first weldment inspection page, the second weldment inspection page and the third weldment inspection page.

6. The method of claim 5, wherein the ordering step includes providing the weldment inspection document on a perceptible medium.

7. The method of claim 6, wherein the part is a frame for an off-highway machine.

8. The method of claim 7, further including the steps of:
accessing an editable representation of a complementary part,
selecting a first weld zone from the editable representation of the complementary part,
marking the first weld zone of the complementary part with indicia concerning the location of and other information regarding the at least one weldment in the first weld zone, and
storing the first weld zone with indicia and other information of the complementary part on the first weldment inspection page.

9. A method for inspecting a part based on a weldment inspection document with respect to weldments located on the part that is fabricated in a manufacturing process, the weldment inspection document providing an inspection sequence including at least a first inspection page with identifications of a first weld criteria in a first weld zone and a second inspection page with identifications of a second weld criteria in a second weld zone, the method comprising:
identifying the first weld zone through reference to the first page in the sequence of inspection pages of the weldment inspection document,
determining whether the first weld zone on the part meets the first weld criteria provided on the first inspection page,
identifying the second weld zone through reference to the second page in the sequence of inspection pages of the weldment inspection document,
determining whether a second weld zone on the part meets the second weld criteria provided on the first inspection page, and
transferring the part to a location for further processing if the first weld zone criteria and the second weld zone criteria are met.

10. The method of claim 9, further including the step of failing the part when either first weld zone criteria or the second weld zone criteria are not met.

11. The method of claim 10, wherein the first weld criteria includes an identification of weld location and associated weld type.

12. The method of claim 11, wherein the second weld criteria includes an identification of weld location and associated weld type.

13. The method of claim 11, wherein the second weld criteria includes an identification of a component finish type in the second weld zone.

14. A physical computer readable medium containing computer executable instructions for creating a weldment inspection document from a grouping of weldment inspection pages provided in an inspection sequence with respect to a part that is made in a manufacturing process according to the following steps:
accessing a three-dimensional electronic representation of the part,
converting the three-dimensional electronic representation to an editable representation of the part,
receiving via a computer interface input from a user selecting a first weld zone in the editable representation of the part,
receiving via the computer interface input from a user indicia concerning the location and other information regarding weldments in the selected first weld zone,
repeating the receiving steps until indicia regarding weldments in remaining weld zones for the part are identified,
storing the weld zones with the indicia concerning the location and other information for the weld zones in the part as a plurality of weldment inspection pages, and
receiving via the computer interface input from a user commands for ordering the plurality of weldment inspection pages in a predefined weldment inspection sequence for the part.

15. The physical computer readable medium of claim 14, wherein the receiving user indicia step further includes marking at least one of the identified weld zones with an identification of a weld type.

16. The physical computer readable medium of claim 15, wherein the receiving user commands for ordering the plurality of weldment inspection pages step includes storing the weld zones on a fixed medium as a weldment inspection document.

17. The physical computer readable medium of claim 16, wherein the part is a frame for an off-highway machine.

18. The physical computer readable medium of claim 17, further including the steps of:
accessing a three dimensional representation of a complementary part,
converting the three-dimensional electronic representation of the complementary part to an editable representation of the complementary part,
receiving via the computer interface input from the user selecting a first weld zone in the editable representation of the complementary part,
receiving via the computer interface input from a user indicia concerning the location and other information regarding weldments in the selected first weld zone of the complementary part,
repeating the receiving steps until indicia regarding weldments in remaining weld zones for the complementary part are identified, and
storing the weld zones with indicia concerning the location and other information of the complementary part on respective weldment inspection pages for the part.
